(19) United States
(12) Patent Application Publication
(10) Pub. No.: US 2015/0362408 A1
(43) Pub. Date: Dec. 17, 2015

(54) CONTROL OPTIMIZATION FOR ENERGY CONSUMING SYSTEMS

(71) Applicant: ENTIC, LLC, Pembroke Pines, FL (US)

(72) Inventors: Manuel Rosendo, Pembroke Pines, FL (US); Bin Zheng, Palmetto Bay, FL (US)

(21) Appl. No.: 14/307,456

(22) Filed: Jun. 17, 2014

(51) Int. Cl. G01M 99/00; G01F 25/00; G01F 1/00; G01K 13/00; G01K 15/00

(52) U.S. Cl. CPC G01M 99/008; G01K 13/00; G01K 15/00; G01F 1/00; G01F 25/0007

(57) ABSTRACT

A method for evaluating sensor accuracy in an energy consuming system to provide control optimization of the energy consuming system, the method including retrieving a threshold value range for the energy consuming system, receiving a data reading from a primary sensor, receiving a data reading from a second sensor, the second sensor related to the primary sensor, receiving a data reading from a third sensor, the third sensor related to the primary sensor and the second sensor, applying triangulation logic to the received data readings, generating a triangulation value, comparing the triangulation value to the threshold value range and when the triangulation value is within the threshold value range, selecting the primary sensor reading.

### BACKGROUND OF THE INVENTION

1. Field of the Invention

The present invention relates to energy consuming systems and more particularly to evaluating sensor accuracy in an energy consuming system to provide control optimization of the energy consuming system.

2. Description of the Related Art

Traditional control systems for energy consuming systems such as heating, ventilation and air conditioning systems (HVAC) are typically categorized as open loop control systems and closed loop control systems. An open control system will make a control decision based on the input without feedback. A closed loop system will make control decisions based on the input but with feedback as illustrated by the circuit in FIG. 1. In a closed loop control system, the controller compares the input value from a single sensor with the control set point, and then makes a control decision utilizing predefined control algorithms. The control command is further sent to the controlled device demonstrated by the process block. The controlled device adjusts its position, on/off, or takes other actions to meet the control reference points. In terms of control rules which are used to make control decisions, the control system can be categorized as a Proportional (P) control loop, a proportional (P) and integral (I) PI control loop, and a proportional (P), integral (I) and deviation (D) PID control loop. Advanced control systems include adaptive controls, fuzzy controls and the like. The control quality of traditional P, PI, and PID controls, and advanced control systems rely on the input to the control loops.

Traditional control systems of energy consuming systems make decisions on single sensor reading, thus the accuracy of the single sensor plays a critical role as to the outcome of the control strategy. For example in HVAC systems, a chiller adjusts its capacity to meet its chilled water leaving temperature set point based on an input from a leaving temperature sensor and the command it receives from the chiller control loop. When the chiller controller identifies that the leaving temperature read from the temperature sensor is not meeting the set point, the chiller controller controls the operation of the compressor and other components to satisfy the set point. In the case where the temperature sensor reading is higher than its actual reading, a chiller consumes more energy to meet the control set point that results in energy wasted; on the other hand, when the temperature sensor reading is lower than its actual value, chilled water with higher temperature is delivered to end users, which potentially leads to comfort and humidity issues. In a similar manner, a room temperature sensor that cannot reflect the real room temperature causes energy waste and/or indoor comfort issues. One major reason for inaccurate control in a control sequence is that a single sensor is providing measurement data in the control decision process. If the sensor data is inaccurate for any reason, e.g., due to lack of calibration or damage, the control loop will make incorrect control decisions that result in comfort issues and energy wastes.

Sensor accuracy is also of vital importance to evaluate energy consuming systems performance and to optimize energy performance. For example, a flow meter with an inaccurate high reading can generate a higher misleading chiller efficiency; on the contrary, a flow meter with a lower reading can lead to underestimated chiller performance, and wasted energy.

As is known, sensors can loose calibration with age, can become defective, or can become faulty due to a multitude of reasons. Reliance on one sensor for control and optimization can bring avoidable errors. An effective method must be used to discern if the sensor readings are reasonable, and send alerts for faulty sensors.

### BRIEF SUMMARY OF THE INVENTION

Embodiments of the present invention address deficiencies of the art in respect to energy consuming systems and provide a novel and non-obvious method, system and computer program product for control optimization for energy consuming systems. In an embodiment of the invention, a method for evaluating sensor accuracy in an energy consuming system to provide control optimization is provided. The method can include retrieving a threshold value range for a sensor of the energy consuming system, receiving a data reading from a primary sensor, receiving a data reading from a second sensor, the second sensor related to the primary sensor, receiving a data reading from a third sensor, the third sensor related to the primary sensor and the second sensor, applying triangulation logic to the received data readings, generating a triangulation value, comparing the triangulation value to the threshold value range and when the triangulation value is within the threshold value range, selecting the primary sensor reading.

In one aspect of the embodiment, the method further including selecting the average reading from the second and third sensors when the triangulation indicates that the primary sensor data is out of the threshold value range. In another aspect of the embodiment, the method further including selecting the average reading from the primary and third sensors when the triangulation indicates that the second sensor data is out of the threshold value range.

In another embodiment, a computer program product for evaluating sensor accuracy in an energy consuming system to provide control optimization of the energy consuming system, the computer program product including a computer readable storage medium having computer readable program code embodied therewith, the computer readable program code including computer readable program code for retrieving a threshold value range for a primary sensor of the energy consuming system, computer readable program code for receiving a data reading from a primary sensor, computer readable program code for receiving a data reading from a second sensor, the second sensor related to the primary sensor, computer readable program code for receiving a data reading from a third sensor, the third sensor related to the primary sensor and the second sensor, computer readable program code for applying triangulation logic to the received data readings, computer readable program code for generating a triangulation value, computer readable program code for comparing the triangulation value to the threshold value range and when the triangulation value is within the threshold value range, computer readable program code for selecting the primary sensor reading

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic of a traditional closed loop control circuit;

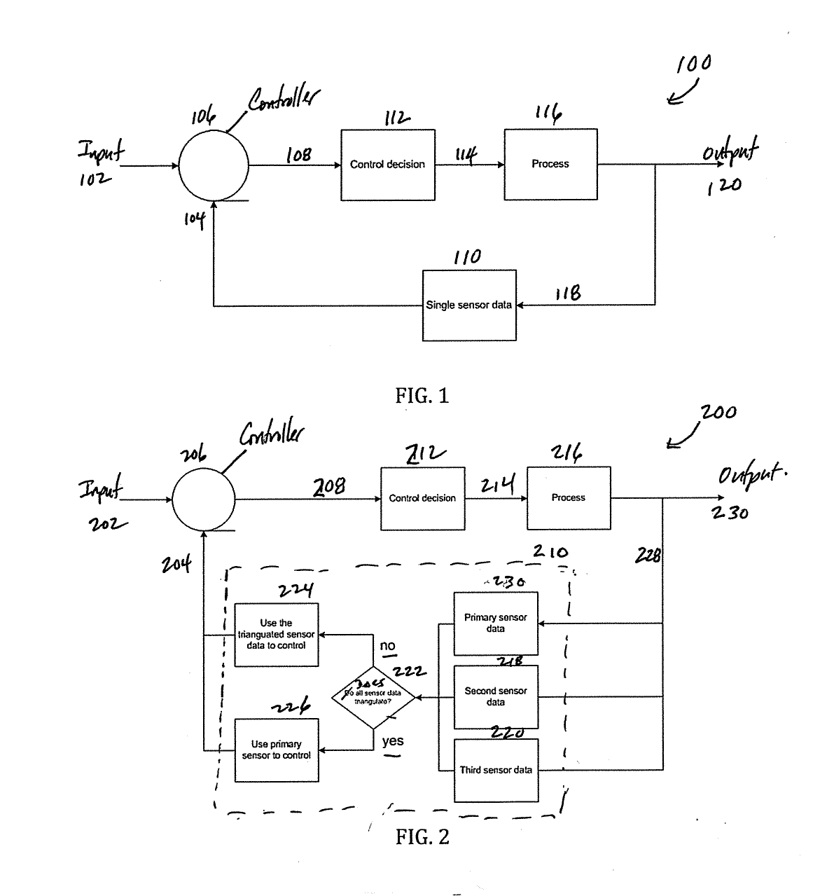

FIG. 2 is a schematic illustrating an improved closed loop control circuit in accordance with one embodiment of the present invention;

FIGS. 3A and 3B are a flow chart illustrating a process for evaluating sensor accuracy in energy consuming systems in accordance with one embodiment of the present invention;

FIG. 4 is a flow chart illustrating the application of the process for evaluating sensor accuracy in energy consuming systems applied to a chiller in a Heating Ventilation and Air-Conditioning (HVAC) system; and

FIG. 5 is a flow chart illustrating a generic process for evaluating sensor accuracy in energy consuming systems in accordance with one embodiment of the present invention.

### DETAILED DESCRIPTION OF THE INVENTION

Embodiments of the invention provide address deficiencies of the art in respect to single point sensor failure in control systems and provide a novel and non-obvious method, system and computer program product for evaluating sensor accuracy in energy consuming systems to provide control optimization of energy consuming systems. In an embodiment of the invention, a method for evaluating sensor accuracy in an energy consuming system to provide control optimization of the energy consuming system can be provided. The method can include receiving sensor data from a plurality of sensors, comparing a primary sensor to a reasonable engineering range, which is a range of values provided by the manufacturer of a component, or subsystem in which the component or subsystem is designed to operate. For example, sensor designers provide an acceptable tolerance range in plus or minus (+/−) a certain percentage (%) and determining whether the primary sensor is within a reasonable engineering range,

In energy consuming systems, sensors are installed to measure different parameters. The readings of those parameters are correlated by engineering principles. To avoid the mistakes due to single sensor failure, the claimed invention makes control decisions based on multiple (at least three) related sensor readings that are evaluated, based on engineering principles. Before an input value is qualified for use by a control loop for the control process decision, the sensor readings are evaluated for accuracy from the multiple sensor readings. The evaluation process involves engineering analysis and triangulation. At the end of the analysis, a qualified reading is sent to the control loop. The qualified reading can be equal to the primary sensor reading or if the primary sensor reading is inaccurate based on the triangulated value, then the qualified reading is the triangulation value. The triangulated value is defined to be the average of the two sensors that have approximately equal values. Thus, the values of the identified two accurate sensors are averaged and that average will be the new sensor reading of the sensors.

This method can be applied to P, PI, and PID control loops, simple on/off controls, and/or adaptive controls. The inventive method is not only applied to any energy consuming systems' control loop strategy, for example: chiller plants, air handling systems, lighting systems, elevator systems, water pump stations, oil pump stations, lift stations, solar cell farms, and the like. The method is also applicable for developing and implementing energy system optimization strategies, and evaluating system performance.

The inventive method evaluates the sensor accuracy before using a sensor reading in the decision making process. The evaluation involves engineering analysis and triangulation from other sensors measuring different parameters. When, by analysis, a primary sensor's reading is in a reasonable engineering range, then the primary sensor's reading is used in the control and optimization algorithms; otherwise, the inventive method will find the alternative sensor readings by engineering analysis. Engineering analysis involves a comparison of whether the reading of the primary sensor in within the acceptance tolerance range with respect to the other two sensors. When the reading of the primary sensor is too far off the tolerance range, the average of the readings of the other two sensors is selected. In certain instances, the primary sensor may be functioning accurately; however, one of the second or third sensors is inaccurate. In this case, the average of the readings of the primary sensor and the accurate sensors of the second or third sensors will be the triangulation value and used in the control loop. Regardless of which sensor is identified as inaccurate, a sensor fault message can be generated to indicate further repair will be necessary. The process is automatic and on going.

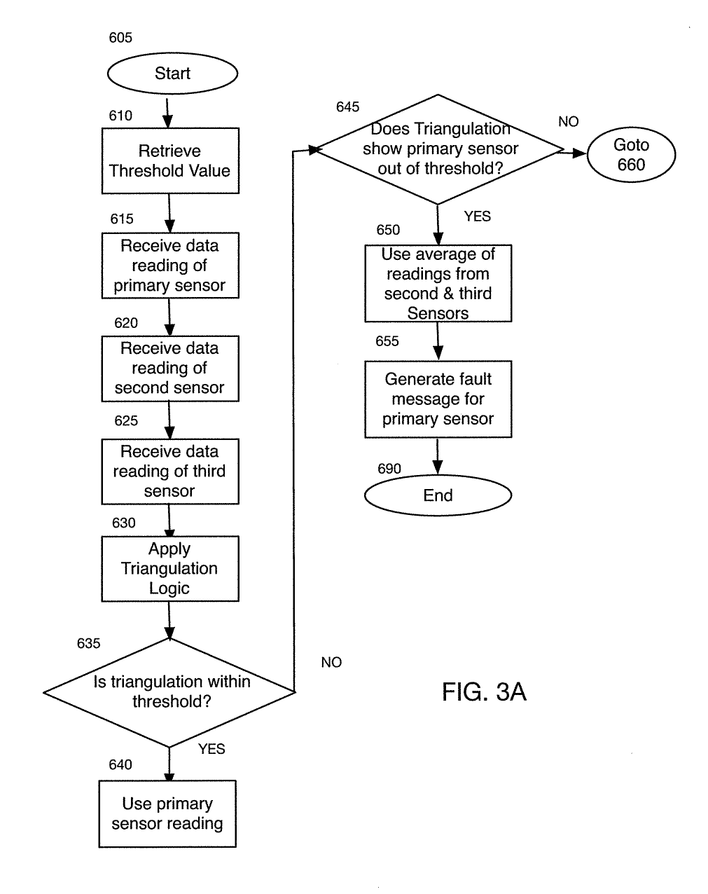

FIG. 2 is a schematic illustrating an improved closed loop control circuit in accordance with one embodiment of the present invention. Closed loop control circuit 200 includes a control set point 202 provided to controller 206 and a qualified feedback input 204 from triangulated feedback circuit 210. Triangulated feedback circuit 210 receives multiple sensors readings 228, such as primary sensor data 230, second sensor data 218 and third sensor data 220. The triangulated feedback circuit 210 evaluates the accuracy of the sensor readings from the multiple sensors using engineering analysis and triangulation. The engineering analysis is checking to make sure the primary sensor is within its specified plus minus (+−%) tolerance value range provided by the sensor manufacturer. At decision block 222, a determination of whether or not all sensor data readings triangulate. If all sensor data readings triangulate, then at block 226 the sensor data of the primary sensor 230 is set to be the qualified reading for use in control decision block 212. On the other hand, if the primary sensor data 230 is determined to be inaccurate based on the triangulated value, then at block 224 the qualified reading is set to be the triangulated value generated for use in control decision block 212. Once control decision 212 receives the qualified reading, control decision 212 makes a control decision utilizing predefined control algorithms. A control command 214 is then generated by control decision block 212 and sent to the controlled device demonstrated by process block 216. The controlled device can adjust its position, its on/off condition, and/or take other actions to meet the control reference points.

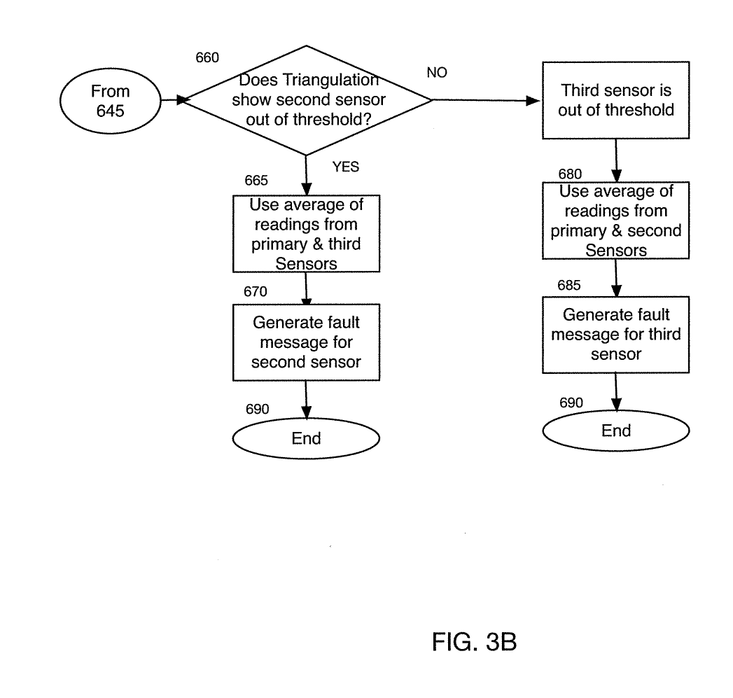

FIGS. 3A and 3B are a flow chart illustrating a process for evaluating sensor accuracy in energy consuming systems in accordance with one embodiment of the present invention. The process for evaluating sensor accuracy in energy consuming systems can commerce in block 605. In block 610, a threshold value can be retrieved. For example, the threshold value can be plus minus percentage tolerance valve provided by a sensor manufacturer. In block 615, a data reading of a primary sensor can be received. In block 620, a data reading of a second sensor that is related to the primary sensor can be received. Next, in block 625, a data reading of a third sensor that is related to the primary sensor can be received. In block 630, triangulation logic can be applied to the data readings of the sensors and a triangulation value can be generated. In decision block 635, the triangulation result can be compared to the threshold value/range. If the triangulation value shows that the primary sensor reading is within the threshold range (e.g., tolerance range), in block 640, the primary sensor reading is used for any control decision. Otherwise, in block 645, if the triangulation shows that the primary sensor data is outside of the threshold, in block 650, the average readings from the second and third sensors are used and in block 655, a fault message for the primary sensor can be generated. If, however, in decision block 645, the triangulation does not show that the primary sensor data is outside of the threshold, in block 660, the second sensor data is compared to the threshold. If the triangulation shows that the second sensor data is outside of the threshold, then in block 665, the average readings from the primary and third sensors are used and in block 670, a fault message for the second sensor can be generated. On the other hand, if the triangulation shows that the second sensor data is not outside of the threshold, then in block 675, the third sensor data is compared to the threshold. If the third sensor data is outside of the threshold, in block 680, the average readings from the primary and second sensors are used and in block 685, a fault message for the third sensor can be generated.

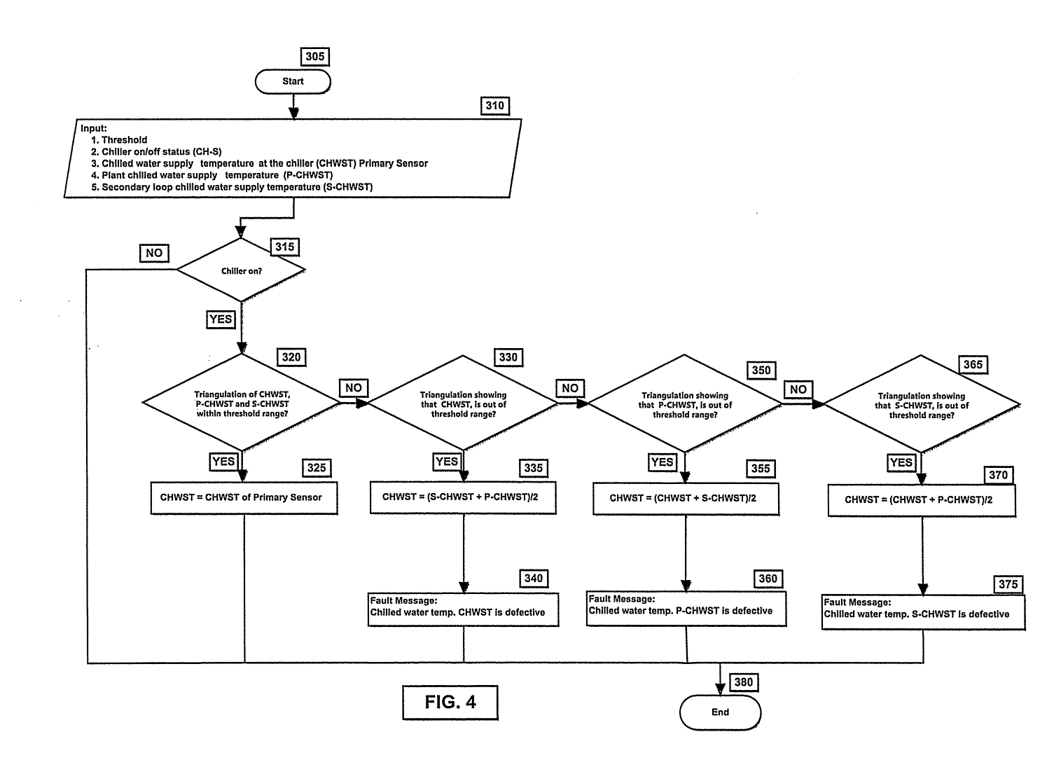

FIG. 4 is a flow chart illustrating a process for evaluating sensor accuracy in energy consuming systems in accordance with another embodiment of the present invention. In this embodiment, the inventive process is applied to a chiller subsystem of a HVAC system. In this embodiment, the chiller is controlled to maintain it chilled water temperature at it set point. The input of the control is the measured chilled water temperature from a sensor installed at the supply water pipe. The process to evaluate the chiller water supply temperature (CHWST) using the inventive triangulation methodology is demonstrated in the flow chart of FIG. 4. The process for evaluating sensor accuracy in a HVAC system can commerce in block 305. In block 310, a threshold value and a chiller on/off status (CH-S) can be received. In addition, in block 310, a chilled water supply temperature at the chiller (CHWST) primary sensor, a plant chilled water supply temperature (P-CHWST) and a secondary loop chilled water supply temperature (S-CHWST) can be received. In decision block 315, an on/off status (CH-S) of the chiller is checked. If the chiller is off, then the process ends at block 380, otherwise in decision block 320, the triangulation result can be compared to the threshold value/range. If the triangulation value is within the threshold range, in block 325, the CHWST of the primary sensor reading is used for any control decision. Otherwise, in block 330, if the triangulation shows that the CHWST of the primary sensor data is outside of the threshold, in block 335, the average readings from the P-CHWST and S-CHWST sensors are used and in block 340, a fault message for the CHWST primary sensor can be generated. If, however, in decision block 330, the triangulation does not show that the CHWST primary sensor data is outside of the threshold, in block 350, the P-CHWST sensor data is compared to the threshold. If the triangulation shows that the P-CHWST sensor data is outside of the threshold, then in block 355, the average readings from the CHWST and S-CHWST sensors are used and in block 360, a fault message for the P-CHWST sensor can be generated. On the other hand, if the triangulation shows that the P-CHWST sensor data is not outside of the threshold, then in block 365, the S-CHWST sensor data is compared to the threshold. If the S-CHWST sensor data is outside of the threshold, in block 370, the average readings from the CHWST and P-CHWST sensors are used and in block 685, a fault message for the S-CHWST sensor can be generated.

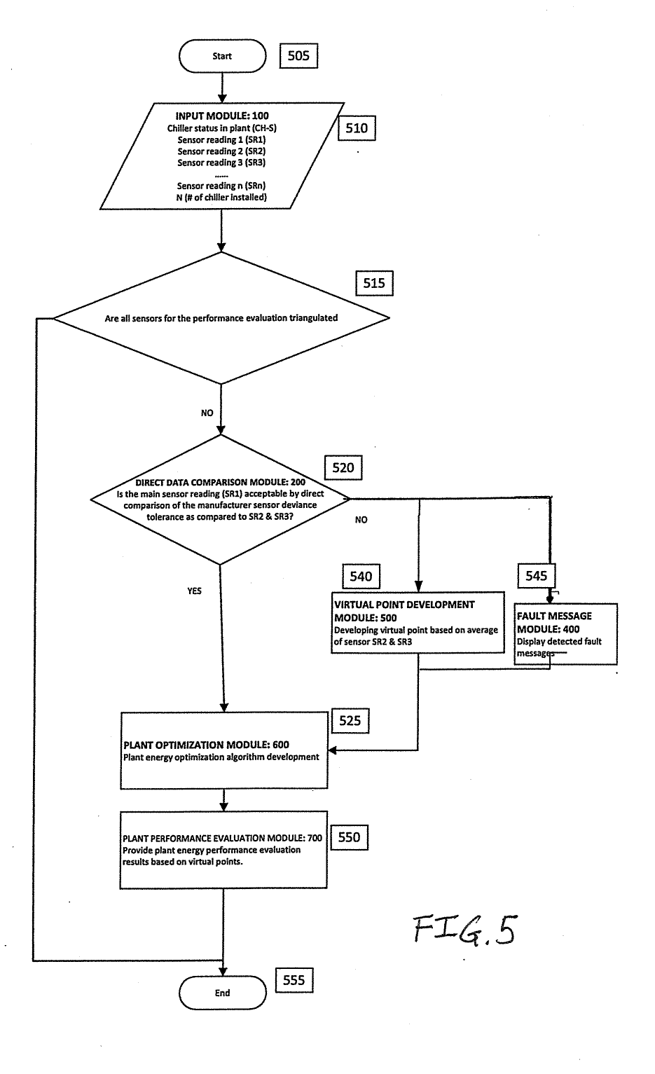

FIG. 5 is a flow chart illustrating a generic process for evaluating sensor accuracy in energy consuming systems in accordance with another embodiment of the present invention. In this embodiment, the inventive process is applied to a subsystem of a plant system. The process for evaluating sensor accuracy in a plant system can commerce in block 505. In block 510, a threshold value (e.g., a deviance tolerance) and a subsystem on/off status (SS-S) can be received. In addition, in block 510, sensor readings 1 through N (SR1-SRN) (where N=the number of subsystems) can be received. In decision block 515, all sensors for the performance evaluation are checked to see if they triangulate within the threshold tolerance range retrieved for the primary sensor. In this sense, the data readings of each of the sensors are compared one to the other and difference values for each pair of sensors are calculated. Thereafter, the difference between primary sensor reading 1 and second sensor reading 2 could be calculated and the difference between primary sensor reading 1 and third sensor reading 3 could be calculated. In this way, the readings of the three sensors have been triangulated and compared. If the all the sensors have been triangulated and all are within the same variance range, then the process ends at block 555, otherwise in decision block 520, the sensor readings are processed by direct comparison to determine if the main sensor reading (SR1) is within an acceptable deviance tolerance range as compared to SR2 and SR3. If the main sensor reading is within the threshold value range of the second sensor reading and third sensor reading then in block 525, a plant energy optimization algorithm using main sensor reading can be developed. Otherwise, in block 540, a virtual point based engineering calculation can be provided. In one embodiment the virtual point based engineering calculation can be taking the average of SR 2 and SR 3. In another embodiment, one of sensors two or three is the inaccurate or faulty sensor then the virtual point based engineering calculation is based on the reading of the main sensor and the accurate sensor. Once a valid virtual point is determined, then in block 525, the plant energy optimization algorithm development can proceed. Meanwhile, in block 545, any detected fault messages are displayed. Finally, in block 550, plant energy performance evaluation results based on virtual points can be provided.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, radiofrequency, and the like, or any suitable combination of the foregoing. Computer program code for carrying out operations for aspects of the present invention may be written in any combination of one or more programming languages, including an object oriented programming language and conventional procedural programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described above with reference to flowchart illustrations and/or block diagrams of methods, apparatus (systems) and computer program products according to embodiments of the invention. In this regard, the flowchart and block diagrams in the Figures illustrate the architecture, functionality, and operation of possible implementations of systems, methods and computer program products according to various embodiments of the present invention. For instance, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

It also will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for evaluating sensor accuracy in an energy consuming system to provide control optimization of the energy consuming system, the method comprising:
retrieving a threshold value range for a primary sensor of the energy consuming system;
receiving a data reading from a primary sensor;
receiving a data reading from a second sensor, the second sensor related to the primary sensor;
receiving a data reading from a third sensor, the third sensor related to the primary sensor and the second sensor;
applying triangulation logic to the received data readings;
generating a triangulation value;
comparing the triangulation value to the threshold value range; and
when the triangulation value is within the threshold value range, selecting the primary sensor reading.

2. The method of claim 1, further comprising selecting the average reading from the second and third sensors when the triangulation indicates that the primary sensor data is out of the threshold value range.

3. The method of claim 2, further comprising selecting the average reading from the primary and third sensors when the triangulation indicates that the second sensor data is out of the threshold value range.

4. The method of claim 3, further comprising selecting the average reading from the primary and second sensors when the triangulation indicates that the third sensor data is out of the threshold value range.

5. The method of claim 2, further comprising generating a fault message from the primary sensor.

6. The method of claim 1, wherein the triangulation value is the difference between the primary sensor reading and the second sensor reading.

7. The method of claim 1, wherein the triangulation value is the difference between the primary sensor reading and the third sensor reading.

8. A computer program product for evaluating sensor accuracy in an energy consuming system to provide control optimization of the energy consuming system, the computer program product comprising:
a computer readable storage medium having computer readable program code embodied therewith, the computer readable program code comprising:
computer readable program code for retrieving a threshold value range for a primary sensor of the energy consuming system;
computer readable program code for receiving a data reading from a primary sensor;
computer readable program code for receiving a data reading from a second sensor, the second sensor related to the primary sensor;
computer readable program code for receiving a data reading from a third sensor, the third sensor related to the primary sensor and the second sensor;
computer readable program code for applying triangulation logic to the received data readings;
computer readable program code for generating a triangulation value;
computer readable program code for comparing the triangulation value to the threshold value range; and
when the triangulation value is within the threshold value range, computer readable program code for selecting the primary sensor reading.

9. The computer program product of claim 8, further comprising computer readable program code for selecting the average reading from the second and third sensors when the triangulation indicates that the primary sensor data is out of the threshold value range.

10. The computer program product of claim 9, further comprising computer readable program code for selecting the average reading from the primary and third sensors when the triangulation indicates that the second sensor data is out of the threshold value range.

11. The computer program product of claim 10, further comprising computer readable program code for selecting the average reading from the primary and second sensors when the triangulation indicates that the third sensor data is out of the threshold value range.

12. The computer program product of claim 9, further comprising computer readable program code for generating a fault message from the primary sensor.
